(19) United States
(12) Patent Application Publication
(10) Pub. No.: US 2018/0029293 A1
(43) Pub. Date: Feb. 1, 2018

(54) METHOD AND DEVICE FOR PRODUCING A THREE-DIMENSIONAL OBJECT

(71) Applicant: Technische Universität München, München (DE)

(72) Inventors: Pascal Bruno Neibecker, München (DE); Hubert Ceeh, München (DE); Josef Andreas Weber, München (DE)

(73) Assignee: Technische Universität München, München (DE)

(21) Appl. No.: 15/551,345

(22) PCT Filed: Feb. 15, 2016
(86) PCT No.: PCT/EP2016/053138

§ 371 Date: Aug. 16, 2017

(30) Foreign Application Priority Data
Feb. 18, 2015 (EP) 15155586.9

(51) Int. Cl. B29C 64/153; B29C 64/393; B33Y 10/00; G10K 11/30; B33Y 50/02; B28B 1/00; G10K 11/34; B29C 64/264; B33Y 30/00

(52) U.S. Cl. CPC B29C 64/153; B29C 64/264; B29C 64/393; B33Y 10/00; B33Y 30/00; B33Y 50/02; B28B 1/001; G10K 11/346; G10K 11/30; B29K 2105/251

(57) ABSTRACT

A method for manufacturing a three-dimensional object comprises making a material avail-able in a material volume and forming a three-dimensional object made of the material by means of selectively irradiating the material with ultrasound.

### CROSS-REFERENCE TO RELATED APPLICATIONS

The instant application is a National Stage application of International Patent Application No. PCT/EP2016/053138 filed on Feb. 15, 2016, which claims priority to European Patent Application No. 15155586.9 filed on Feb. 18, 2015.

### FIELD OF THE INVENTION

The invention refers to a method and an apparatus to manufacture a three-dimensional object, in particular, to a generative or additive manufacturing method, such as 3D printing.

### BACKGROUND OF THE INVENTION

Generative or additive manufacturing methods, particularly 3D printing methods have, in the meanwhile, established themselves as quick and cost-effective manufacturing methods for models, samples, prototypes, tools, but also increasingly for the manufacture of final products. This method comprises manufacturing directly on the basis of computer-stored data models using shapeless (liquids, powder, etc) or shape-neutral (e.g. band-shaped or wire-shaped) source materials by means of chemical and/or physical processes.

In the case of selective electron-beam melting or electron-beam sintering, a focused electron beam writes onto a fine powder. In the case of electron-beam melting, the powder is completely melted and in the case of sintering, it is at least partially melted. By the repeating application of the powder in combination with the melting or sintering process, three-dimensional objects can be constructed, as described in U.S. Pat. No. 5,597,589 as an example. The technical requirements for such a system are however very high, already due to the use of an electron beam alone. On the one hand, the lenses used for focusing the beam are expensive and bulky. On the other hand, the entire system must be operated within a vacuum. In addition, selective electron-beam melting requires powder to be applied in layers, whereby the achievable printing speed is limited.

Selective laser melting is similar to electron-beam melting, whereby a laser (primarily a CO2 laser, an Nd:YAG laser or a fibre laser) is used instead of an electron beam. In contrast to electron-beam melting, the requirement to operate the entire system within a vacuum is done away with. But the use of a protective gas still remains indispensable. The printing speed is also limited using this method due to the necessity to apply the powder in layers.

In the case of the fused deposition modelling method, objects are created by applying plastics layer by layer. For this purpose, the plastic is melted and pressed by an extruder. In order to be able to print any type of shape, under certain circumstances, it is necessary to print additional support constructions (so-called “supports”). A fused deposition modelling method is described in the application document WO 2001/026023 as an example. The precision of printing is primarily limited due to the diameter of the extruder. Commercial models offer resolutions within the range of only approximately 0.5 mm, which are insufficient for many industrial applications. The printing speed is limited due to the transverse speed of the nozzle.

So-called multi jet modelling is similar to inkjet printing and achieves high levels of resolution. In a first variation, special resins are applied that are exposed to an ultraviolet light source in the next step and hardened. In a second variation, a powder is applied in layers, that is printed with an adhesive. In this way, both plastics as well as metals and ceramics can be printed. For both of the last named materials however, additional manufacturing steps are required under certain circumstances in order to obtain the desired material properties, for example, tempering, filling the adhesive gaps etc. Multi jet modelling is expensive with regard to purchasing the system and the maintenance thereof, and therefore it is primarily interesting for industrial applications.

For the stereolithography, —being similar to multi-jet modelling— a liquid artificial resin is used which hardens when exposed to light. A laser writes directly into the container where the artificial resin is located. By gradually raising the fluid level, a three-dimensional object can be constructed piece by piece. Such a method is described in the application document DE 2012 10011418 as an example. Stereolithography achieves a very high resolution. However, it requires movable components, such as wipers to evenly distribute the polymer for example, which decreases printing speed.

Against the background of the aforementioned problems, an improved method or an improved apparatus is required that makes the quick and cost-effective manufacture of three-dimensional objects possible, preferably in any type of shape.

### BRIEF DESCRIPTION OF THE SEVERAL VIEWS OF THE DRAWING(S)

FIG. 1 schematically illustrates an apparatus to form a three-dimensional object, as well as the related method to form the three-dimensional object in accordance with an embodiment of the invention;

FIGS. 2a and 2b show schematic variations of the embodiment in FIG. 1 with a plurality of ultrasound sources;

FIG. 3 schematically illustrates the formation of a three-dimensional object by melting a granulate along a construction element in accordance with an embodiment of the invention;

FIG. 4 schematically illustrates an ultrasound unit with a phased-array ultrasound source in accordance with an embodiment of the invention; and

FIG. 5 schematically illustrates the formation of a focused ultrasonic beam in a phased-array ultrasound source.

### DETAILED DESCRIPTION OF THE INVENTION

This objective is solved using the method according to the invention in accordance with Claim 1 or the apparatus according to the invention according to Claim 11. The dependent claims refer to beneficial further developments.

The method according to the invention for manufacturing a three-dimensional object comprises making a material available in a material space and forming a three-dimensional object made of the material by means of selectively irradiating the material with ultrasound.

The inventors have recognized that selectively irradiating the material with ultrasound makes forming three-dimensional objects directly from three-dimensional material spaces possible at a high level of reproducibility. Since the shape of the three-dimensional object is achieved by selectively irradiating the material with ultrasound, almost any type of shape is possible. In addition, in contrast to conventional 3D printing methods, movable components can be done without to a great extent. By means of this, high printing speeds can be achieved. At the same time, doing without movable components reduces manufacturing costs and maintenance requirements.

In addition, irradiating with ultrasound results in a reduced level of thermal stress on the material or the three-dimensional object in comparison to conventional printing methods, so that it is possible to work with a variety of materials.

A material in terms of the invention can be any material that is appropriate to change its material properties and/or its phase under the influence of ultrasound irradiation, in particular melt when subjected to ultrasound irradiation.

According to the invention, the materials of made available in a material space. Any receptacle that holds the material can serve as a material space in terms of the invention.

Forming a three-dimensional object made of the material by means of selectively irradiating the material with ultrasound may, in particular, take place within the material space itself. Thereby, in contrast to many conventional 3D printing methods, the requirement to transport the material or the source material to the printing zone can be done without so that the complexity of the printing apparatus can be reduced and the printing speed can be increased.

In a preferred embodiment, the selective irradiation of the material takes place along a predefined path through the material.

In particular, the path may correspond to the structure of the three-dimensional object.

In this way, the solution according to the invention makes forming a three-dimensional object with almost any predefined structure possible by moving an ultrasonic beam through the material along a path that corresponds to the predefined structure.

Preferably, the selective irradiation comprises focusing the ultrasonic beam onto a plurality of predefined areas of the material, preferably focusing an ultrasonic beam onto a first predefined area of the material and then onto a second predefined area of the material.

By focusing the ultrasonic beam, the energy input into the material to form the three-dimensional object can be specifically controlled and with a high level of spatial and temporal resolution. Thereby, in particular, the ultrasonic beam can be focused onto selected areas of the material corresponding to a structural design plan for the three-dimensional object in order to form the structures of the three-dimensional object there. This has a great advantage with relation to conventional 3D printing methods that only make the construction of a three-dimensional object possible layer by layer.

Focusing the ultrasound onto predefined areas of the material can furthermore take place in a quick manner without movable parts so that the solution according to the invention can achieve high printing speeds.

In particular, focusing the ultrasound can take place using a focusing optics. The focusing optics can include one or a plurality of lenses, for example, Plexiglas lenses.

As an alternative or additionally, focusing of the ultrasound can take place using a phased-array ultrasound source.

The phased-array ultrasound source can include a plurality of ultrasound elements, for example, piezoelectric transducers, which emit ultrasound signals that are phase-delayed with respect to each other. The resulting ultrasonic beam results from overlapping these individual signals and can be focused in a quick manner and with a high level of precision onto any areas of the material space by appropriately selecting the phase delay.

In a preferred embodiment, the selective irradiation of the material includes the irradiation of the material using at least a first ultrasonic beam and at least a second ultrasonic beam.

In this way, by using a plurality of ultrasound sources, various areas of the material space can be irradiated at the same time and, in this way, various sections of the three-dimensional object can be formed simultaneously. The printing speed can further be increased by means of this.

In a preferred further development of the invention, the first ultrasonic beam and the second ultrasonic beam are focused from various spatial directions within a predefined area of the material.

By means of this, the energy density can be additionally increased at the predefined area of the material by means of combining the energy input of a plurality of ultrasonic beams. In this way, an increase of the printing speed can be achieved.

Forming a three-dimensional object can, in particular, comprise melting the material by selectively irradiating the material with ultrasound.

In this embodiment, the three-dimensional object can be formed by solidifying and binding the material associated therewith along the predefined path through the material.

In a preferred embodiment, the material includes a granulate.

A granulate in terms of the embodiment includes any granular or powdery solid.

In particular, the granulate may include thermoplastic polymers, in particular, acrylonitrile butadiene styrene (ABS), polyamide (PA), polylactic acid (PLA), polymethyl methacrylate (PMMA), polycarbonate (PC), polyethylene terephthalate (PET), polyethylene (PE), polypropylene (PP), polystyrene (PS), polyether ether ketone (PEEK) and/or polyvinyl chloride (PVC).

By melting the granulate using ultrasound, almost any three-dimensional structures can be formed in a precise manner with a high level of spatial resolution.

The material can comprise a fibre-reinforced granulate, more preferably, a granulate reinforced with glass fibres and/or carbon fibres. By means of this, and especially stable structure can be achieved.

In a preferred embodiment, the material comprises a metal granulate and/or a ceramic granulate.

The granules can, in particular be covered (“coated”) with a polymer layer.

In a preferred embodiment, the granulate has a granulate size of no less than 25 μm, preferably not less than 50 μm.

In a preferred embodiment, the granulate does not have a granulate size of more than 2 mm, preferably not more than 1 mm and in particular, not more than 200 μm.

The preceding upper and lower granulate size limits can refer to the average particle size of the granulate in particular.

In a preferred embodiment, the material comprises various granulates.

In particular, these various granulates can be spatially present within the space of material at various mixture ratios. This brings about a spatial variation of the mechanical and physical properties determined by the material composition.

In particular, granulates can be selected that melt with each other when subjected to ultrasound, mix, react and/or collectively solidify. In this way, the mechanical properties of the three-dimensional object can be varied.

In a preferred embodiment, polymer granulates can be mixed with glass or carbon fibres within the material space so that a fibre-reinforced composite is produced upon solidification.

However, the invention is not limited to granulates as materials.

In an embodiment, the material comprises a monomer solution.

Forming the three-dimensional object can, in particular, comprise initiating an emulsion polymerization and/or a co-polymerization by means of the selective irradiation of the monomer solution with ultrasound.

In this way, the monomer, acrylonitrile for example, can be spatially polymerized by the focused ultrasound in order to precisely form a three-dimensional structure.

The use of granulate and a monomer solution as a material are not mutually exclusive. In particular, a monomer-granulate suspension can be used as a material, which is linked at points by means of irradiating with ultrasound.

In a preferred embodiment, the material comprises a ceramic and/or a metal.

In this embodiment, forming the three-dimensional object can, in particular, comprise sintering the ceramic and/or the metal by selectively irradiating with ultrasound.

In a preferred embodiment, the ultrasound has a wavelength of no more than 16 mm, preferably not more than 8 mm and, in particular, not more than 2 mm. In the air, this corresponds to frequencies of at least 20 kHz, at least 40 kHz or at least 160 kHz, respectively.

The inventors have recognized that three-dimensional objects made of the material, in particular by melting a granulate, can be formed using these relatively low frequencies in a reliable and reproducible manner. Ultrasound signals at this low frequency range can additionally be generated in a simple and cost-effective manner.

In a preferred embodiment, the ultrasound comprises a wavelength of no less than 10 μm, preferably no less than 20 μm and, in particular, no less than 50 μm. In the air, the wavelengths indicated correspond to frequencies of 30 MHz at the most, 15 MHz at the most or 6.5 MHz at the most, respectively.

The inventors have recognized that a sufficiently high level of spatial resolution and sufficiently high level of energy import can be achieved using these frequencies.

In particular, the invention may comprise adapting the impedance of the material and, if required, the space between the material through a matching medium, which can include a fluid and, in particular, an organic fluid.

By varying the intensity of the ultrasound, the mechanical properties of the three-dimensional object can be varied.

In a preferred embodiment, forming the three-dimensional object comprises the selective irradiation of the material with ultrasound at a first frequency and the selective irradiation of the material with ultrasound at a second frequency, which is different from the first frequency.

By specifically varying the frequencies of the ultrasound, the printing speed can further be increased. For example, a first frequency to form a melting zone in the granulate can be transmitted and afterwards a second frequency different from the first frequency can be transmitted at a higher absorption coefficient to expand the melting zone or to keep it in liquid state.

In particular, forming a three-dimensional object can comprise forming a cavitation zone in the material by selectively irradiating the material with ultrasound.

In this way, non-linear effects can specifically be taken advantage of, for example, in the melting zone of the granulate. Within the melted material, the ultrasound absorption characteristics are different in comparison to loose granules. In particular, by forming a cavitation zone, a significantly higher absorption coefficient and energy input can be achieved due to the associated increase in the number of degrees of freedom.

In a preferred embodiment, the method comprises the additional step of providing a construction element in the material space, whereby the construction element is at least, in part, adjacent to the material or surrounded by the material, and forming the three-dimensional object comprises selectively linking the material to the construction element.

In particular, the selective linking of the material to the construction element can comprise irradiating the material with ultrasound at a boundary surface between the material and the construction element.

Any prefabricated body that is suitable to provide the three-dimensional object with stability or be absorbed into the three-dimensional object during the formation process can be used as a construction element. In particular, the construction element can include a plastic element or an element made of another source material, such as a ceramic element or a metallic element.

The use of suitably shaped construction elements that are different from the material can make a time-consuming formation of large interrelated volumes unnecessary. By means of this, the printing speed can be further increased.

In the preceding embodiments, forming the three-dimensional object from the material by means of selectively irradiating the material with ultrasound has been described. In addition, however, ultrasound can also be used in order to specifically remove material from the (printed) three-dimensional object. In particular, removing material from the three-dimensional object can include dissolving or disintegrating sections of the three-dimensional object by means of specific irradiation with ultrasound.

Due to the use of ultrasound, when removing material, direct visual contact between the ultrasound source and the section of the object to be removed is not necessary, thereby enabling very complex shapes to be achieved.

This embodiment allows an especially high level of variability when manufacturing three-dimensional objects due to the combination of applying and removing material.

The invention also makes reference to an apparatus to manufacture a three-dimensional object with an ultrasound unit that is adapted to selectively irradiate a material made available in a material space with ultrasound.

Preferably, the apparatus includes a focusing unit to focus the ultrasound onto the various predefined areas of the material.

The focusing unit may include at least one lens, more preferably at least one acoustic lens.

As an alternative or additionally, the ultrasound unit or the focusing unit may include a phased-array ultrasound source.

In a further development of the invention, the ultrasound unit includes a plurality of ultrasound sources that are arranged with various spatial orientations towards the material space and/or are configured to provide various frequencies of ultrasound.

In a further development of the invention, the apparatus also includes the material space to hold the material.

The material space can be a reservoir to hold the material.

In an embodiment, the apparatus includes a control device to provide control signals to focus the at least one ultrasonic beam of the ultrasound unit onto selected areas of the material in accordance with a predefined path which corresponds to the three-dimensional object to be manufactured.

The control device can, in particular, be adapted to process a structural design plan of the three-dimensional object to be manufactured and provide related control signals based upon the structural design plan.

In a preferred embodiment, the apparatus is adapted to implement the method with one or a plurality of the aforementioned features.

The invention also makes reference to a computer program and/or a computer program product with computer-readable instructions that adapted to execute a method with one or a plurality of the aforementioned features on a processing unit that is connected to an apparatus with one or a plurality of the aforementioned features.

### DETAILED DESCRIPTION OF PREFERRED EMBODIMENTS

The features and numerous advantages of the solution according to the invention can be best understood using a detailed description of the preferred embodiments taking the figures into account.

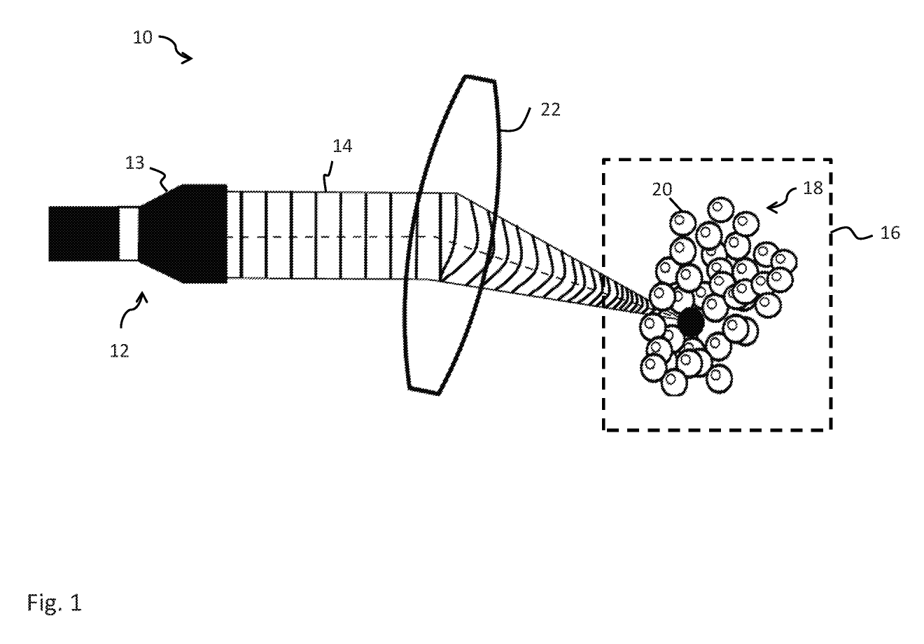

FIG. 1 is a schematic illustration of an apparatus 10 for manufacturing a three-dimensional object (not shown) in accordance with an embodiment of the invention. The apparatus 10 includes an ultrasound unit 12 with an ultrasound source 13 that is configured to generate an ultrasonic beam 14 and send it out towards a material 18 made available in a material space 16.

The ultrasound source 13 can include an arrangement or an array of piezoelectric ultrasound transducers (not shown) that are set up to send out an ultrasound signal at a frequency between 40 and 100 kHz. Such ultrasound sources require a relatively low level of instrumental and constructional effort, are compact, and inexpensive to manufacture.

In the illustration shown in FIG. 1, the material 18 is made up of loose granulate with a variety of granules 20, for example, made of acrylonitrile butadiene styrene (ABS) with an average granule size of 50 μm to 100 μm. However, within the scope of the invention, granulates made of other materials, such as polyamide (PA), polylactic acid (PLA), Polymethyl methacrylate (PMMA), polycarbonate (PC), polyethylene terephthalate (PET), polyethylene (PE), polypropylene (PP), polystyrene (PS), polyether ether ketone (PEEK) and/or polyvinyl chloride (PVC), can be used for example.

However, the invention is not limited to granular materials 18, but can also be implemented using liquid materials, such as a monomer solution for example.

The material space 16 is shown as a dashed box in the schematic illustration of FIG. 1. It can be designed as a container made of a material that is permeable to ultrasound, for example, and hold the granulate or the monomer solution. The container can additionally accommodate an interconnecting layer, made up of a liquid to level out the refractive index.

Furthermore, FIG. 1 also shows a focusing unit 22, using which the ultrasonic beam 14 can be focused on to various selected areas of the material 18.

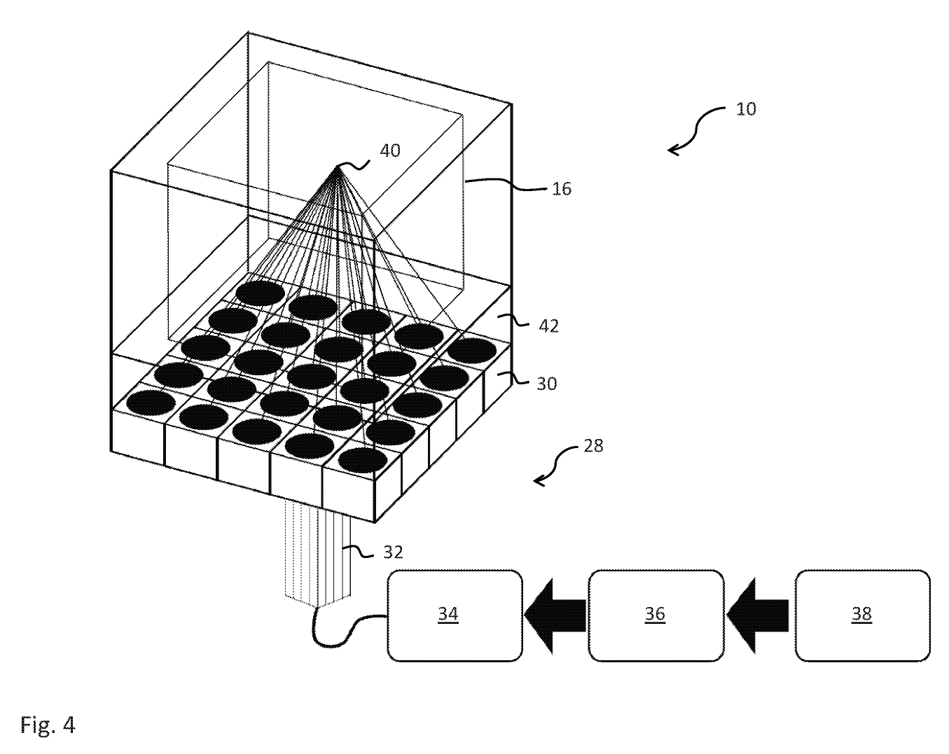

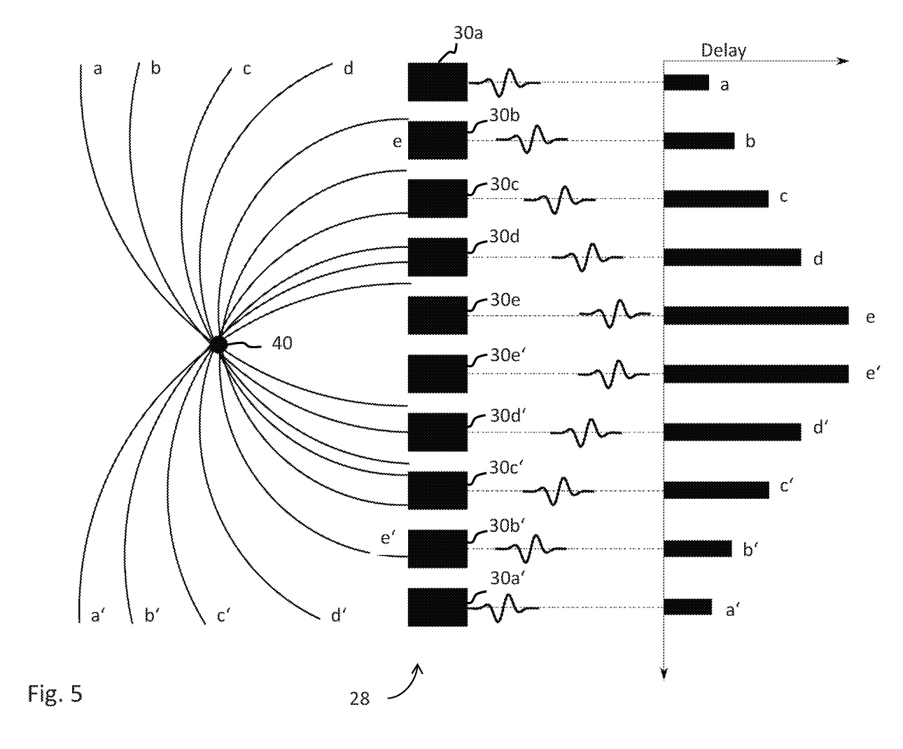

In FIG. 1, the focusing unit is schematically illustrated as a lens. It can include one or a plurality of acoustic lenses, for example, Plexiglas lenses. However, the invention is not limited to lenses. An alternative configuration which is described in the following making reference to FIGS. 4 and 5, focusing the ultrasonic beam 14 onto selected areas of the material 18 takes place using a phased-array ultrasound source.

Focusing the ultrasonic beam 14 allows the selective and specific application of energy to selected areas of the loose granulate 18. Due to the energy input of the ultrasonic beam 14, the granulates bodies 20 at the site of the application of energy are melted and bind with adjacent granules during subsequent solidification into a solid structure. In this process the ultrasound power is primarily absorbed by the granules 20. At the boundary surface to the surrounding air, the removal of heat is disturbed and the temperature within the granulate 18 increases. When sufficient power is applied, the melting temperature is exceeded and the granules 20 melt. If the ultrasonic beam 14 is moved along a predefined path through the granulate 18 using the focusing unit 22, a three-dimensional structure, meaning a three-dimensional object, forms along this path due to the melting of the granulate 18 and the subsequent solidification.

The three-dimensional object can be any three-dimensional object, for example a prototype of a workpiece or of a tool. An advantage of the solution according to the invention includes the ultrasonic beam 14 and the resulting melting zone can be moved three-dimensional along any path through the granulate so that any related structures can be formed when solidified.

Focusing of the ultrasonic beam 14 allows a limited application of energy onto a very small spatial area of the material space 16, therefore making the formation of three-dimensional objects possible with a higher level of spatial resolution and fine structures. For example, the application of 10 W of power into a space of approx. 3 mm3 with a diameter of approximately 2 mm allows for the melting of a PE granulate.

The schematic illustration of FIG. 1 shows an apparatus 10 with an ultrasound unit 12 comprising a single ultrasound source 13. However, embodiments of the invention can also include a plurality of ultrasound sources assigned to the ultrasound unit 12, which can be arranged in various orientations in relation to the material space 16. The corresponding ultrasound sources can send out ultrasonic beams having an identical frequency, however, can also differ in their related frequencies.

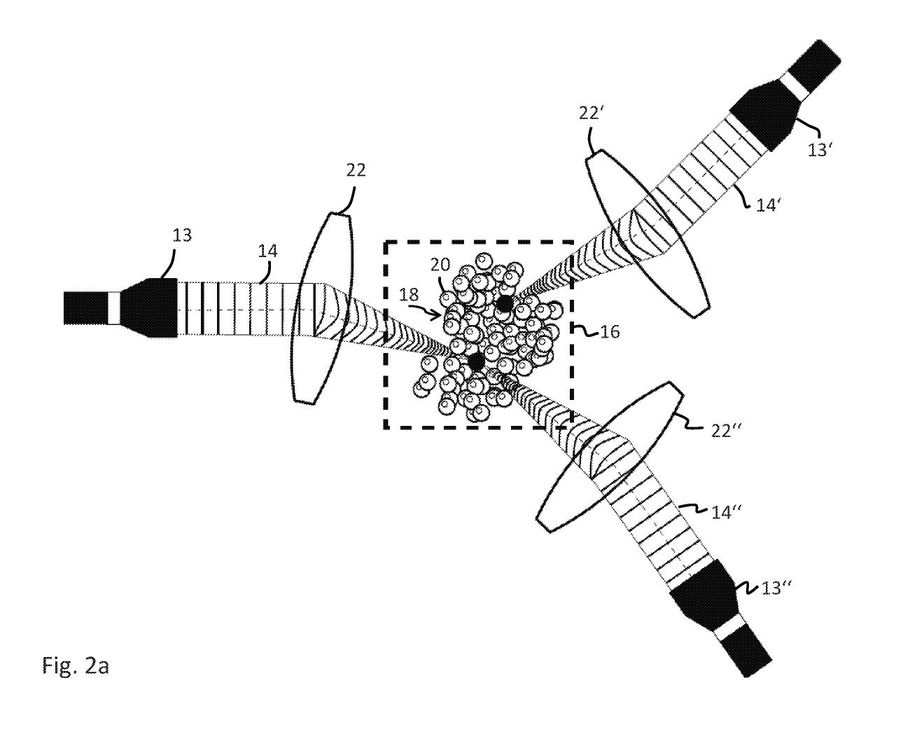

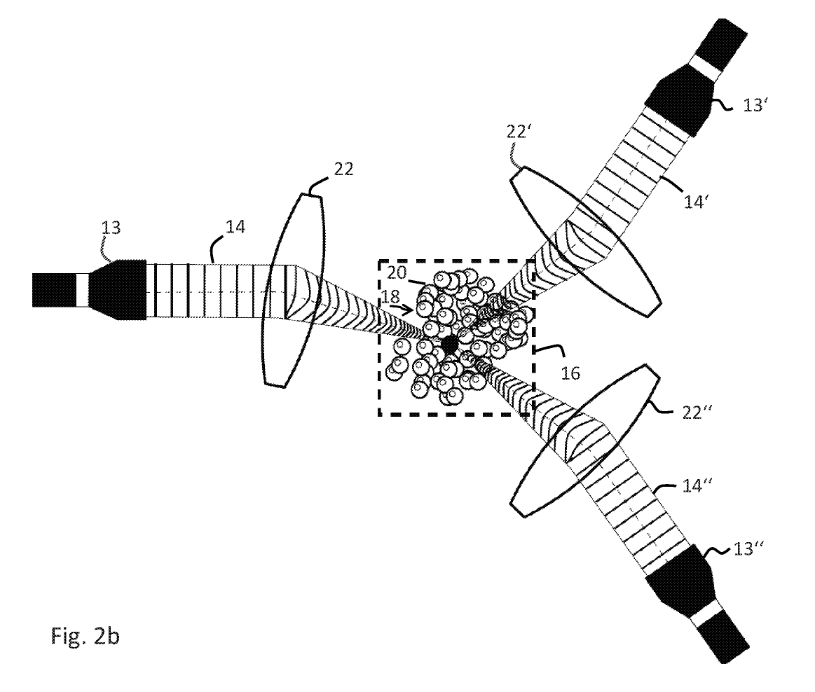

FIG. 2a shows a configuration where the ultrasound unit 12 includes three ultrasound sources, 13, 13′ and 13″, which are arranged with various spatial orientations to the material 18 around the material space 16. Each of the ultrasound sources, 13, 13′ and 13″, generate a corresponding ultrasonic beam, 14, 14′ or 14″, that is respectably focused on selective areas within the material space 16 by means of a corresponding lens 22, 22′ or 22″. The construction and control of the ultrasound sources, 13, 13′ and 13″, or the related lenses, 22, 22′ and 22′, corresponds to the preceding embodiment described with reference to FIG. 1.

In the configuration of FIG. 2a, both lenses 22 and 22″ focus the beams 14, 14″ onto a first area within the material space 16 and the third lens 22′ focuses the beam 14′ onto a second area within the material space that is different from the first area. In this way, various sections of the three-dimensional object can be worked on at the same time in order to form corresponding melting zones there, whereby the manufacturing speed can be considerably increased.

An alternative embodiment is shown in FIG. 2b. With regard to its construction, it corresponds to the embodiment shown in FIG. 2a to a great extent. However, all three lenses, 22, 22′ and 22″ focus onto a collective area of the material space 16 in order to increase the energy input there at a local level.

By using various frequencies, non-linear effects in the melting zone can be specifically taken advantage of. The melted material differs from loose granulate with regard to its ultrasound absorption properties. By forming cavitation zones in the melting zone, the absorption coefficient can be considerably increased for example. Irradiating the granulate 18 with a first frequency can, in particular, serve to form a melting zone, while irradiating with a second frequency that is different from the first frequency with a higher absorption coefficient may serve to expand the melting zone and keep it in liquid form.

By varying the intensity of the ultrasound at various areas of the material space 16, the mechanical properties of the three-dimensional object can be varied.

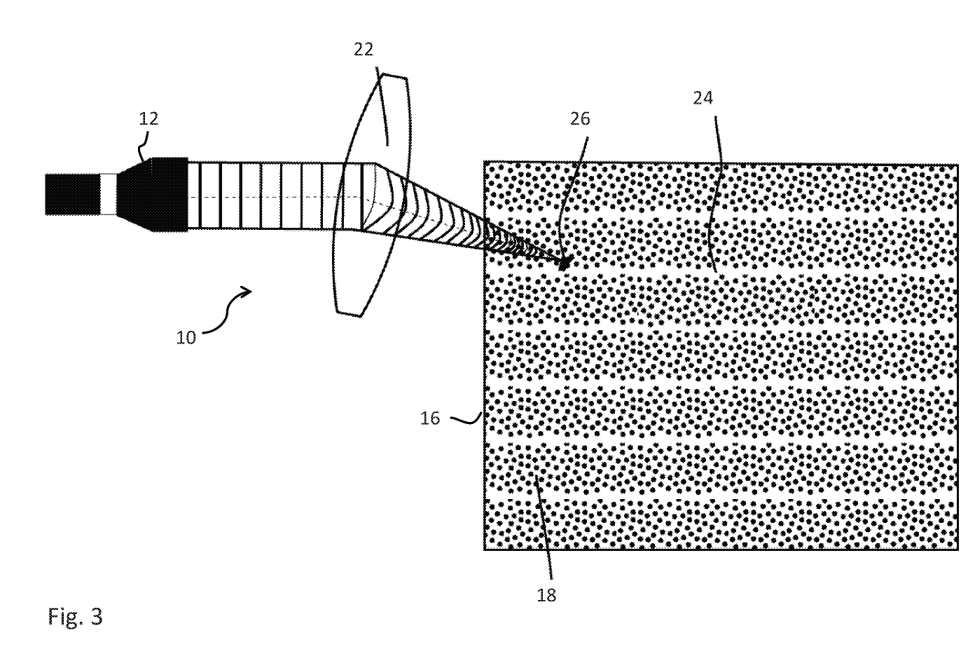

The embodiment shown in FIG. 3 differs from the embodiment shown in FIG. 1 only in the fact that the material space 16 has additional prefabricated construction elements 24 in addition to the material 18, which are shown in the cross-section illustration in FIG. 3 as a light strip within the loose granulate.

The construction elements 24 can be metal bodies or synthetic bodies made of plastic with a higher melting temperature than the surrounding granulate 18. The construction elements 24 can be formed in various ways and introduced into the material space 16 at predefined positions. FIG. 2 shows a configuration where the granulate 18 is selectively melted in the area of a boundary surface 26 between the granulate 18 and the construction element 24 so that the melted granulate 18 binds with the construction element 24 during subsequent solidification. In this way, predefined construction elements 24 can be specifically absorbed into the three-dimensional object. The use of such construction elements makes the time-consuming printing of large interrelated spaces unnecessary.

FIG. 4 shows an embodiment of an apparatus 10 according to the invention, in which the ultrasound is generated to irradiate the material using a phased-array ultrasound source 28.

The phased-array ultrasound source 28 includes an arrangement or an array of a plurality of ultrasound transducers 30 that are connected to corresponding transducer power amplifiers 34 via a power bus 32. The transducer amplifiers 34 are controlled by a control device 36 that generates control signals to generate ultrasound pulses based on a structural design plan for the three-dimensional object created using a design program 38.

The principle of generating a focused ultrasonic beam 14 in the phased-array ultrasound source 28 has been illustrated in FIG. 5.

FIG. 5 shows a phased-array ultrasound source 28 with 10 ultrasound transducers, 30a to 30e and 30a′ to 30e′, that are arranged towards each other in a predefined spatial configuration and are individually controlled by the control device 36 via the transducer power amplifiers 34 and the power bus 32 (not shown here) in order to transmit ultrasound signals. As is shown in the right-handed partial schematic illustration of FIG. 5 using a bar chart, the transmission of wavefronts of the ultrasound signals occurs with a phase delay with respect to one another, whereby the same phase is assigned to each of the pairs, 30a/30a′, 30b/30b′, 30c/30c′, 30d/30d′ and 30e/30e′. By appropriately selecting the phase delay between these pairs, focusing the ultrasound waves sent out by the individual ultrasound transducers, 30a to 30e and 30a′ to 30e′, onto any point of focus 40 can be achieved. The overlapping of individual waves at the point of focus 40 is schematically illustrated in the left partial illustration shown in FIG. 5.

In the illustration shown in FIG. 4, the ultrasound waves transmitted by the ultrasound transducers 30 are shown as rays for the sake of a clear representation, which unite at the point of focus 40. By appropriately selecting the phase delay, the point of focus 40 within the material space 16 can be moved quickly in any direction in order to achieve energy input at a specifically local level and thereby to melt the granulate along a predefined melting path. Using a phased-array ultrasound source 28, the three-dimensional object can be produced along a predefined melting path in a way similar to the lens 22 shown in FIGS. 1 and 2, however, without moving parts.

Coupling the ultrasound signals of the ultrasound transducers 30 in the material space 16 can be made easier by means of a coupling layer 42 to even out the refractive index.

FIG. 4 shows a configuration with only one phased-array ultrasound source 28. Similar to the embodiments described with reference to FIGS. 1 and 2, a plurality of phased-array ultrasound sources can however be arranged around the material space or the container 16 in order to increase the energy input at a local level or be able to melt various spatial areas of the material 18 simultaneously.

The description of the preferred embodiments and the figures solely serve to illustrate the invention and the benefits achieved with the invention, however, they should not limit the invention. The scope of the invention solely derives from the following claims.

1. A method for manufacturing a three-dimensional object, comprising:
providing a material in a material space; and
forming a three-dimensional object from the material by selectively irradiating the material with ultrasound.

2. The method according to claim 1, wherein the selective irradiating of the material takes place along a predefined path through the material, wherein the path corresponds to a structure of the three-dimensional object.

3. The method according to claim 1, where the selective irradiating comprises focusing the ultrasound onto a plurality of predefined areas of the material.

4. The method according to claim 1, where the selective irradiating of the material comprises focusing the ultrasound using a focusing optics and/or using a phased-array ultrasound source.

5. The method according to claim 1, wherein the selective irradiating of the material comprises irradiating the material with at least a first ultrasonic beam and at least a second ultrasonic beam, wherein, the first ultrasonic beam and the second ultrasonic beam are coming from different spatial directions and are focusing onto a predefined area of the material.

6. The method according to claim 1, wherein the material comprises a granulate.

7. The method according to claim 1, wherein forming the three-dimensional object comprises melting the material by selectively irradiating the material with ultrasound.

8. The method according to claim 1, wherein forming the three-dimensional object comprises selectively irradiating the material with ultrasound at a first frequency and selectively irradiating the material with ultrasound at a second frequency, and wherein the second frequency is different from the first frequency.

9. The method according to claim 1, further comprising providing a construction element in the material space, wherein the construction element is at least, in part, adjacent to the material, and wherein forming the three-dimensional object comprises selectively linking the material to the construction element.

10. The method according to claim 1, further comprising removing material from the three-dimensional object by means of selectively irradiating the three-dimensional object with ultrasound.

11. An apparatus for manufacturing a three-dimensional object, comprising:
an ultrasound unit that is configured to selectively irradiate with ultrasound a material provided in a material space.

12. The apparatus according to claim 11, further comprising a focusing unit associated with the ultrasounds unit and operating to focus the ultrasound onto various predefined areas of the material, wherein the focusing unit includes at least one of a lens and a phased-array ultrasound source.

13. The apparatus according to claim 11, wherein the ultrasound unit comprises a plurality of ultrasound sources, each of the plurality of ultrasound sources being arranged in one of various spatial orientations towards the material space and operating to provide one of various frequencies of ultrasound.

14. The apparatus according to claim 11, further comprising the material space, wherein the material space is defined in a container configured for holding the material.

15. (canceled)

16. The method according to claim 6, wherein the granulate is a thermoplastic polymer.

17. The method according to claim 16, wherein the thermoplastic polymer material is selected from the group consisting of acrylonitrile butadiene styrene (ABS), polyamide (PA), polylactic acid (PLA), polymethyl methacrylate (PMMA), polycarbonate (PC), polyethylene terephthalate (PET), polyethylene (PE), polypropylene (PP), polystyrene (PS), polyether ether ketone (PEEK) and polyvinyl chloride (PVC).

18. A computer program with computer-readable and computer-executable instructions, comprising:
instructions for operating an ultrasound unit associated with, and responsive to, commands provided by a computer that operates the computer-readable and executable instructions, the computer-readable and executable instructions including (a) instructions for emitting ultrasound and (b) instructions for selectively focusing the ultrasound onto predefined areas of a material disposed in a material space;
wherein the computer operates the ultrasound unit to focus the emitted ultrasound along a predefined path through the material, the predefined path corresponding to a structure of a three-dimensional object.

19. The computer program of claim 18, wherein the commands provided by the computer are configured to, at least one of, focus optics associated with the ultrasound unit and control a phased-array ultrasound source.

20. The computer program of claim 18, wherein the commands provided by the computer operate the ultrasound device to irradiate the material with at least a first ultrasonic beam and at least a second ultrasonic beam, the first ultrasonic beam and the second ultrasonic beam coming from different spatial directions and being focused onto a predefined area of the material.

21. The computer program of claim 18, wherein the commands provided by the computer operate the ultrasound device to irradiate the material with ultrasound at a first frequency and with ultrasound at a second frequency, the first and second frequencies being different.
